(19) United States
(12) Patent Application Publication
(10) Pub. No.: US 2012/0208090 A1
(43) Pub. Date: Aug. 16, 2012

(54) MICROPOROUS MEMBRANES, METHODS FOR MAKING SUCH MEMBRANES, AND THE USE OF SUCH MEMBRANES

(76) Inventors: Patrick Brant, Seabrook, TX (US); Sadakatsu Suzuki, Nasushiobara-shi (JP); Yoichi Matsuda, Nasushiobara-shi (JP); Kotaro Takita, Nasushiobara-shi (JP)

(21) Appl. No.: 13/364,490

(22) Filed: Feb. 2, 2012

Related U.S. Application Data
(60) Provisional application No. 61/443,384, filed on Feb. 16, 2011.

(51) Int. Cl. H01M 2/16; B29C 47/00; B32B 5/00; C08L 23/20; C08L 23/02; C08L 23/06; C08L 23/12; B29C 55/02; B32B 3/26

(52) U.S. Cl. 429/246; 264/291; 264/210.1; 428/220; 521/143; 521/134

(57) ABSTRACT

The invention relates to microporous membranes comprising first and second components, the first component being polymer and the second component being aliphatic paraffin having a backbone and pendent groups. The invention also relates to methods for making such membranes, and the use of such membranes, e.g., as battery separator film.

### FIELD OF THE INVENTION

The invention relates to microporous membranes comprising first and second components, the first component being polymer and the second component being aliphatic paraffin having a backbone and pendent groups. The invention also relates to methods for making such membranes, and the use of such membranes, e.g., as battery separator film.

### BACKGROUND OF THE INVENTION

Microporous membranes are useful as separators for primary and secondary batteries, including lithium ion secondary batteries, lithium-polymer secondary batteries, nickel-hydrogen batteries, nickel-cadmium batteries, nickel-zinc batteries, silver-zinc batteries, etc. Such membranes can be produced, for example, by a “wet” process involving extruding a polymer-diluent mixture and then removing at least a portion of the diluent from the extrudate. See, e.g., U.S. Pat. No. 5,051,183.

Polymers useful for producing microporous membranes include, for example, polyolefins such as polyethylene and polypropylene. U.S. Pat. No. 6,054,498 discloses microporous membranes produced from polyethylenes such as low density polyethylene, high density polyethylene, and ultra-high molecular weight polyethylene. Polyethylene can be used in combination with other polyolefins such as polypropylene, as disclosed in, e.g., PCT Patent Publication No. WO 2010/055812, for example. As disclosed in these references, the diluent can be, e.g., paraffin oil having a kinetic viscosity of 20-200 mm²/sec at 40° C. Although the paraffin oil diluent is compatible with polyolefin at extrusion temperatures and can be removed from the extrudate to produce a microporous membrane, improved diluents are still desired.

### SUMMARY OF THE INVENTION

The invention relates to membranes comprising first and second components, the first component being polymer and the second component being aliphatic paraffin; methods for making such membranes; and the use of such membranes, e.g., as battery separator film. In an embodiment, the invention relates to a membrane comprising (a) ≧90.0 wt. % polymer (first component) having an Mw≧1.0×10⁵ and (b) ≧0.01 wt. % aliphatic paraffin (second component), the aliphatic paraffin having (i) an average carbon number in the range of C₂₀ to C₁₅₀₀ and (ii) ≧1 pendent group having a carbon number ≧C₄ per six backbone carbon atoms, weight percents being based on the weight of the membrane; wherein the membrane is microporous.

In another embodiment, the invention relates to a method for producing a microporous membrane, comprising:

stretching in at least a first direction a sheet comprising ≧5.0 wt. % polymer and ≧50.0 wt. % diluent, the weight percents being based on the weight of the sheet, wherein the diluent comprises ≧0.01 wt. % based on the weight of the diluent of aliphatic paraffin having (i) an average carbon number in the range of C₂₀ to C₁₅₀₀ and (ii) ≧1 pendent group having a carbon number ≧C₄ per six backbone carbon atoms; and then removing at least a portion of the diluent from the stretched sheet.

In yet another embodiment, the invention relates to a battery comprising an electrolyte, an anode, a cathode, and a separator situated between the anode and the cathode; the separator comprising (a) ≧90.0 wt. % polymer (first component) having an Mw≧1.0×10⁵ and (b) ≧0.01 wt. % aliphatic paraffin (second component), the aliphatic paraffin having (i) an average carbon number in the range of C₂₀ to C₁₅₀₀ and (ii) ≧1 pendent group having a carbon number ≧C₄ per six backbone carbon atoms, weight percents being based on the weight of the separator.

In yet another embodiment, the invention relates to a battery separator film produced from aliphatic paraffin and polymer having an Mw≧1.0×10⁵, the aliphatic paraffin having (i) an average carbon number in the range of C₂₀ to C₁₅₀₀ and (ii) first repeating units derived from one or more oligomers of a first α-olefin; wherein the first α-olefin has ≧6 carbon atoms.

In yet another embodiment, the invention relates to a battery separator film comprising ≧90.0 wt. % polymer having an Mw≧1.0×10⁵ and ≧0.01 wt. % aliphatic paraffin, the weight percents being based on the weight of the battery separator film; the aliphatic paraffin (i) comprising ≧1.0 wt. % of first repeating units based on the weight of the aliphatic paraffin and (ii) having an average carbon number in the range of C₂₀ to C₁₅₀₀; wherein the first repeating units comprise ≧1 pendent group having a carbon number ≧C₄ per six backbone carbon atoms.

### DETAILED DESCRIPTION OF THE INVENTION

It has been observed that the presence of very high and very low-molecular weight molecules in conventionally-used paraffin oil and its tendency to oxidize at extrusion temperatures leads to the following difficulties in producing microporous membranes by extrusion:
(a) a build-up of carbonaceous deposits on extruder equipment, particularly extruder screws;
(b) a reduced membrane porosity and an undesirable membrane morphology;
(c) a deposition of oxidation residue, e.g., “smoke” produced from low molecular weight ends in the paraffin oil on to the extrudate, sheet, and finished membrane;
(d) mixing difficulties resulting from the change in the paraffin oil viscosity vs. temperature characteristics; and
(e) an undesirably slow rate of diluent removal from extrudate.
   The invention is based on the discovery that these difficulties can be at least partially obviated, thereby producing microporous membrane of improved strength and permeability at higher yield, by producing the microporous membrane using aliphatic paraffin having (i) an average carbon number in the range of C₂₀ to C₁₅₀₀ and (ii) ≧1 pendent group having a carbon number ≧C₄ per six backbone carbon atoms (referring to the backbone of the aliphatic paraffin). Optionally, the membrane has a thickness ≦25.0 μm, a 105° C. heat shrinkage in at least one direction ≦10.0%, a shutdown temperature ≦140.0° C., and a meltdown temperature ≧145.0° C. Optionally, the membrane comprises ≧0.10 wt. % of the aliphatic paraffin and further comprises ≦1.0 wt. % (including 0.0 wt. %) of a second paraffin, the second paraffin (i) including ≦20.0 wt. % of pendent groups, e.g., ≦10.0 wt. %, such as ≦1.0.0 wt. % of pendent groups, the weight percent being based on the weight of the membrane and/or (ii) having ≦1 pendent group having a carbon number ≧C₄ per six backbone carbon atom, e.g., ≦0.5, such as ≦01.

Selected embodiments will now be described in more detail, but this description is not meant to foreclose other embodiments within the broader scope of the invention. For the purpose of this description and appended claims, the term “polymer” means a composition including a plurality of macromolecules, the macromolecules containing recurring units derived from one or more monomers. The macromolecules can have different size, molecular architecture, atomic content, etc. The term polymer includes macromolecules such as copolymer, terpolymer, etc. “Polyethylene” means polyolefin containing ≧50.0% (by number) recurring ethylene-derived units, preferably polyethylene homopolymer and/or polyethylene copolymer wherein at least 85% (by number) of the recurring units are ethylene-derived units. “Polypropylene” means polyolefin containing ≧50.0% (by number) recurring propylene-derived units, preferably polypropylene homopolymer and/or polypropylene copolymer wherein at least 85% (by number) of the recurring units are propylene-derived units.

A “microporous membrane” is a thin film having pores, where ≧90.0 percent (by volume) of the film's pore volume resides in pores having average diameters in the range of from 0.01 μm to 10.0 μm. With respect to membranes produced from extrudates, the machine direction (“MD”) is defined as the direction in which an extrudate is produced from a die. The transverse direction (“TD”) is defined as the direction perpendicular to both MD and the thickness direction of the extrudate. MD and TD can be referred to as planar directions of the membrane, where the term “planar” in this context means a direction lying substantially in the plane of the membrane when the membrane is flat.

The term “paraffin” means a hydrocarbon, including mixtures of thereof, to substantially of formula CₙH₂ₙ₊₂, including those which are oligomers and isomers, e.g., n-paraffins, branched paraffins, isoparaffins, and cycloparaffins. The term hydrocarbon includes, e.g., one or more of naturally-occurring hydrocarbon, hydrocarbon derived from naturally-occurring hydrocarbon, synthetically-produced hydrocarbon, hydrocarbon derived from synthetically-produced hydrocarbon, hydrocarbon derived from non-hydrocarbon sources, e.g., those synthesized from hydrogen and carbon atoms, etc. The term “aliphatic paraffin” means a paraffin wherein ≧95.0% of the paraffin's carbon atoms (by number) are linked in open-chains. An aliphatic paraffin comprises a backbone having one initial group and one terminal group (at least one of which groups can be, e.g., a single atom, such as a carbon atom), the initiating and terminating groups being bound to the backbone at the opposed ends of the aliphatic paraffin. The term backbone includes the initial and terminal groups, but excludes pendent groups, side chains, branches, etc. The term “backbone carbon atom” means a designated carbon atom covalently bound to at least first and second carbon atoms, wherein (a) the first carbon atom is included in the initial group or is connected thereto via repeating units which do not include either the second carbon atom or the designated carbon atom and (b) the second carbon atom is included in the terminal group or is connected thereto via repeating units which do not include either the first carbon atom or the designated carbon atom. The term “pendent group” means a group bound to a backbone carbon atom. The term pendent group includes hydrocarbon of at least methyl order, branches, side chains, functional groups, etc. Pendent groups can be characterized by an average number of carbon atoms, which is equal to the total number of carbon atoms in the aliphatic paraffin's pendent groups divided by the total number of pendent groups.

A “non-functionalized paraffin” means a paraffin which does not contain an appreciable amount of functional groups, e.g., groups containing one or more of hydroxide, aryl and substituted aryl, halogen, alkoxy, carboxylate, ester, acrylate, carboxyl, oxygen, nitrogen, or sulfur. The term “appreciable amount of functional groups”, means that these groups or species comprising these groups are not added to the paraffin, and if present at all, are present in an amount ≦2.0 wt. % based on the weight of the paraffin, e.g., ≦1.0 wt. %, such as ≦0.1 wt. %. The term “oligomer” means a molecule having a number-average molecular weight (“Mn”)≦1.0×10⁴ and containing recurring units derived from one or more monomers. The term oligomer as used in this description and appended claims refers to molecules having the specified Mn and recurring units, without regard to the way such molecules are produced. The term “PAO” means C₂₀ to C₁₅₀₀ polyalphaolefin, and mixtures thereof, comprising ≧95.0 wt. % based on the weight of the PAO of oligomers (dimers, trimers, tetramers, pentamers, hexamers, etc.) that (i) are derived from linear olefin having 6 to 15 carbon atoms, e.g., 6 to 14 carbon atoms, such as 8 to 12 carbon atoms, and (ii) have a kinematic viscosity at 100° C. ≧3.0 mm²/sec and a Viscosity Index ≧120.0. The methods used for determining number and arrangement of carbon atoms, Mn, kinematic viscosity, and Viscosity Index are described in U.S. Pat. No. 7,795,366 which is incorporated by reference herein in its entirety. The amount of aliphatic hydrocarbon and its composition can be determined, e.g., by conventional nuclear magnetic resonance methods.

### Materials Used to Produce the Microporous Membrane

In an embodiment, the microporous membrane is made by extruding a mixture of (i) polymer and (ii) diluent. At least a portion of the diluent is removed during the process to provide the membrane with at least some porosity. The polymer can be, e.g., polyolefin or a polyolefin mixture. The diluent can comprise ≧0.1 wt. %, based on the weight of the diluent, aliphatic paraffin having (i) an average carbon number in the range of C₂₀ to C₁₅₀₀ and (ii) ≧1 pendent group having a carbon number ≧C₄ per six backbone carbon atoms. Although the invention is described in terms of membranes produced by extrusion of polymer and diluent, it is not limited thereto, and this description is not meant to foreclose other embodiments within the broader scope of the invention such as membranes produced from polymer and aliphatic paraffin in a “dry” process. Polymer and diluent, such as those that are suitable for producing the microporous membrane by extrusion in a wet process, will now be described in more detail.

### Polymer

In an embodiment, the membrane is produced from polymer comprising polyolefin, e.g., polyethylene, polypropylene, and/or polymethylpentene. The polyolefin can have, e.g., an Mw≧5.0×10⁵, and an MWD≦20.0. Examples of polyethylene and polypropylene that may be useful for producing selected membrane embodiments by extrusion will now be described. The invention is not limited to the polymers described below, and this description is not meant to foreclose other polymers within the broader scope of the invention.

### Polyethylene

In an embodiment, the polyethylene (“PE”) comprises, e.g., a single PE species or a mixture or reactor blend of polyethylene, such as a mixture of two or more polyethylenes (“PE1”, “PE2”, “PE3”, “PE4”, etc., as described below). For example, the PE may include a blend of (i) a first PE (PE1) and optionally second (PE2), third (PE3), and/or fourth (PE4) PEs.

### PE1

In an embodiment, the first PE (“PE1”) can be, e.g., a PE having a weight average molecular weight (“Mw”)≦1.0×10⁶, e.g., in the range of from about 1.0×10⁵ to about 0.90×10⁶; a molecular weight distribution (“MWD” defined as Mw/Mn)≦50.0, such as ≦20.0, e.g., in the range of from about 2.0 to about 20.0; and a terminal unsaturation amount≦0.20 per 1.0×10⁴ carbon atoms. Optionally, PE1 has an Mw in the range of from about 4.0×10⁵ to about 6.0×10⁵, and an MWD of from about 3.0 to about 10.0. Optionally, PE1 has an amount of terminal unsaturation 0.14 per 1.0×10⁴ carbon atoms, or 0.12 per 1.0×10⁴ carbon atoms, e.g., in the range of 0.05 to 0.14 per 1.0×10⁴ carbon atoms (e.g., below the detection limit of the measurement). A non-limiting example of PE1 is one having an Mw in the range of from about 3.0×10⁵ to about 8.0×10⁵, for example, about 5.6×10⁵, and an MWD of from about 2.0 to about 10.0. PE1 can be produced, e.g., in a process using a Ziegler-Natta catalyst or a single-site polymerization catalyst.

### PE2

In an embodiment, the second PE (“PE2”) can be, e.g., PE having an Mw ≦1.0×10⁶, e.g., in the range of from about 2.0×10⁵ to about 0.9×10⁶, an MWD≦50.0, e.g., in the range of from about 2 to about 20.0, and a terminal unsaturation amount≧0.20 per 1.0×10⁴ carbon atoms. Optionally, PE2 has an amount of terminal unsaturation ≧0.30 per 1.0×10⁴ carbon atoms, or ≧0.50 per 1.0×10⁴ carbon atoms, e.g., in the range of 0.6 to 10.0 per 1.0×10⁴ carbon atoms. A non-limiting example of PE2 is one having an Mw in the range of from about 3.0×10⁵ to about 8.0×10⁵, for example, about 7.5×10⁵, and an MWD of from about 4.0 to about 15.0.

PE1 and/or PE2 can be, e.g., an ethylene homopolymer or an ethylene/α-olefin copolymer containing 5.0 mole % of one or more comonomer such as α-olefin, based on 100% by mole of the copolymer. Optionally, the α-olefin is one or more of propylene, butene-1, pentene-1, hexene-1,4-methylpentene-1, octene-1, vinyl acetate, methyl methacrylate, or styrene. Such a PE can have a melting point≧132° C. PE2 can be produced, e.g., in a process using a chromium-containing catalyst. The amount of terminal unsaturation can be measured in accordance with the procedures described in PCT Patent Publication No. WO 1997/23554, for example.

### PE3

In an embodiment, PE3 can be, e.g., PE having a Tm ≦130.0° C. Using PE3 having a Tm ≦130.0° C. can provide the finished membrane with a desirably low shutdown temperature, e.g., a shutdown temperature ≦130.5° C. Optionally, PE3 has a Tm ≧85.0° C., e.g., in the range of from 105.0° C. to 130.0° C., such as 115.0° C. to 126.0° C. Optionally, the PE3 has an Mw ≦5.0×10⁵, e.g., in the range of from 1.0×10³ to 4.0×10⁵, such as in the range of from 1.5×10³ to about 3.0×10⁵. Optionally, the PE3 has an MWD≦5.0, e.g., in the range of from 2.0 to 5.0, e.g., 1.8 to 3.5. Optionally, PE3 has a mass density in the range of 0.905 g/cm³ to 0.935 g/cm³. Polyethylene mass density is determined in accordance with ASTM D1505.

In an embodiment, PE3 is a copolymer of ethylene and ≦5.0 mole % of a comonomer such as one or more of propylene, butene-1, pentene-1, hexene-1,4-methylpentene-1, octene-1, vinyl acetate, methyl methacrylate, styrene, or other monomer. Optionally, the comonomer amount is in the range of 1.0 mole % to 5.0 mole %. In an embodiment, the comonomer is hexene-1 and/or octene-1. PE3 can be produced in any convenient process, such as those using a Ziegler-Natta or single-site polymerization catalyst. Optionally, PE3 is one or more of a low density polyethylene (“LDPE”), a medium density polyethylene, a branched LDPE, or a linear LDPE, such as a PE produced by metallocene catalyst. PE3 can be produced according to the methods disclosed in U.S. Pat. No. 5,084,534 (such as the methods disclosed therein in examples 27 and 41), which is incorporated by reference herein in its entirety. Optionally, PE3 is not used to produce the membrane and, if present, is present in an amount≦1.0 wt. % based on the weight of the membrane.

### PE4

In an embodiment, the fourth PE (“PE4”) can be, e.g., PE having an Mw≧1.0×10⁶, e.g., in the range of from about 1.0×10⁶ to about 5.0×10⁶ and an MWD≦20.0, e.g., in the range of from about 1.2 to about 20.0. A non-limiting example of PE4 is one having an Mw of from about 1.0×10⁶ to about 3.0×10⁶, for example, about 2.0×10⁶, and an MWD ≦20.0, e.g., of from about 2.0 to about 20.0, preferably about 4.0 to about 15.0. It is believed that using such a PE can provide the membrane with higher strength. PE4 can be, e.g., an ethylene homopolymer or an ethylene/α-olefin copolymer containing ≦5.0 mole % of one or more comonomers such as α-olefin, based on 100% by mole of the copolymer. The comonomer can be, for example, one or more of, propylene, butene-1, pentene-1, hexene-1,4-methylpentene-1, octene-1, vinyl acetate, methyl methacrylate, or styrene. Such a polymer or copolymer can be produced using a Ziegler-Natta or a single-site catalyst, and can have a melting point 134° C.

The melting points of PE1-PE4 can be determined using the methods disclosed in PCT Patent Publication No. WO 2008/140835, for example. In an embodiment, the PE is a mixture of polyethylenes, e.g., a mixture of (a) PE1 and/or PE2, (b) PE4, and, optionally, (c) PE3.

### Polypropylene

In an embodiment, the polypropylene (“PP”) can be, e.g., polypropylene having an Mw≧6.0×10⁵, such as ≧7.5×10⁵, for example, in the range of from about 0.8×10⁶ to about 3.0×10⁶, such as in the range of from 0.9×10⁶ to 2.0×10⁶. Optionally, the PP has a Tm 160.0° C. and a ΔHm ≧90.0 J/g, e.g., ≧100.0 J/g, such as in the range of from 110 J/g to 120 J/g. Optionally, the PP has an MWD≦20.0, e.g., in the range of from about 1.5 to about 10.0, such as in the range of from about 2.0 to about 8.5. It has been observed that using an effective amount of such a PP can improve the membrane's stability at high temperature (e.g., can increase the member's meltdown temperature). Optionally, the PP is a copolymer (random or block) of propylene and ≦5.0 mole % of a comonomer, the comonomer being, e.g., one or more α-olefins such as ethylene, butene-1, pentene-1, hexene-1,4-methylpentene-1, octene-1, vinyl acetate, methyl methacrylate, and styrene, etc.; or diolefins such as butadiene, 1,5-hexadiene, 1,7-octadiene, 1,9-decadiene, etc.

In an embodiment, the PP is isotactic polypropylene. In an embodiment, the PP has an amount of stereo defects ≦about 50.0 per 1.0×10⁴ carbon atoms, e.g., ≦ about 20.0 per 1.0×10⁴ carbon atoms, or ≦about 10.0 per 1.0×10⁴ carbon atoms, such as ≦about 5.0 per 1.0×10⁴ carbon atoms. Optionally, the PP has one or more of the following properties: (i) a Tm ≧162.0° C.; (ii) an elongational viscosity ≧about 5.0×10⁴ Pa sec at a temperature of 230° C. and a strain rate of 25 sec⁻¹; (iii) a Trouton's ratio≧about 15 when measured at a temperature of about 230° C. and a strain rate of 25 sec⁻¹; (iv) a Melt Flow Rate (“MFR”; ASTM D-1238-95 Condition L at 230° C. and 2.16 kg)≦about 0.1 dg/min, e.g., ≦ about 0.01 dg/min (e.g., an MFR that is essentially not measurable); or (v) an amount extractable species (extractable by contacting the PP with boiling xylene)≦0.5 wt. %, e.g., ≦0.2 wt. %, such as ≦0.1 wt. % or less based on the weight of the PP.

In an embodiment, the PP is an isotactic PP having an Mw in the range of from about 0.9×10⁶ to about 2.0×10⁶, an MWD 8.5, e.g., in the range of from 2.0 to 8.5, e.g., in the range of from 2.5 to 6.0, and a ΔHm ≧90.0 μg. Generally, such a PP has an amount of stereo defects ≦about 5.0 per 1.0×10⁴ carbon atoms, and a Tm ≧162.0° C.

A non-limiting example of the PP, and methods for determining the PP's Tm, meso pentad fraction, tacticity, intrinsic viscosity, Trouton's ratio, stereo defects, and amount of extractable species are described in PCT Patent Publication No. WO 2008/140835, which is incorporated by reference herein in its entirety.

The PP's ΔHm is determined by the methods disclosed in PCT Patent Publication No. WO 2007/132942, which is incorporated by reference herein in its entirety. Tm can be determined from differential scanning calorimetric (DSC) data obtained using a Perkin Elmer Instrument, model Pyris 1 DSC. Samples weighing approximately 5.5-6.5 mg are sealed in aluminum sample pans. The DSC data are recorded by first heating the sample to 230° C. at a rate of 10° C./minute, called first melt (no data recorded). The sample is kept at 230° C. for 10 minutes before a cooling-heating cycle is applied. The sample is then cooled from about 230° C. to about 25° C. at a rate of 10° C./minute, called “crystallization”, then kept at 25° C. for 10 minutes, and then heated to 230° C. at a rate of 10° C./minute, called (“second melt”). The thermal events in both crystallization and second melt are recorded. The melting temperature (Tₘ) is the peak temperature of the second melting curve and the crystallization temperature (T_{c}) is the peak temperature of the crystallization peak.

### Other Species

Optionally, inorganic species (such as species containing silicon and/or aluminum atoms), and/or heat-resistant polymers such as those described in PCT Patent Publication Nos. WO 2007/132942 and WO 2008/016174 (both of which are incorporated by reference herein in their entirety) can be present in the membrane. In an embodiment, the membrane contains 1.0 wt. % of such materials, based on the weight of the membrane. A small amount of other species, e.g., processing aids, antioxidants, and the like can also be present in the membrane, generally in amounts less than 1.0 wt. % based on the weight of the membrane.

### Mw and MWD Determination

Polymer Mw and MWD (and those of the aliphatic hydrocarbon) can be determined using a High Temperature Size Exclusion Chromatograph, or “SEC”, (GPC PL 220, Polymer Laboratories), equipped with a differential refractive index detector (DRI). The measurement is made in accordance with the procedure disclosed in “Macromolecules, Vol. 34, No. 19, pgs. 6812-6820 (2001)”. Three PLgel Mixed-B columns (available from Polymer Laboratories) are used for the Mw and MWD determination. For PE, the nominal flow rate is 0.5 cm³/min; the nominal injection volume is 300 μL; and the transfer lines, columns, and the DRI detector are contained in an oven maintained at 145° C. For PP, the nominal flow rate is 1.0 cm³/min; the nominal injection volume is 300 μL; and the transfer lines, columns, and the DRI detector are contained in an oven maintained at 160° C.

The GPC solvent used is filtered Aldrich reagent grade 1,2,4-Trichlorobenzene (TCB) containing approximately 1000 ppm of butylated hydroxy toluene (BHT). The TCB is degassed with an online degasser prior to introduction into the SEC. The same solvent is used as the SEC eluent. Polymer solutions are prepared by placing dry polymer in a glass container, adding the desired amount of the TCB solvent, and then heating the mixture at 160° C. with continuous agitation for about 2 hours. The concentration of polymer solution is 0.25 to 0.75 mg/ml. Sample solutions are filtered off-line before injecting to GPC with 2 μm filter using a model SP260 Sample Prep Station (available from Polymer Laboratories).

The separation efficiency of the column set is calibrated with a calibration curve generated using seventeen individual polystyrene standards ranging in Mp (“Mp” being defined as the peak in Mw) from about 580 to about 10,000,000. The polystyrene standards are obtained from Polymer Laboratories (Amherst, Mass.). A calibration curve (log Mp vs. retention volume) is generated by recording the retention volume at the peak in the DRI signal for each PS standard and fitting this data set to a 2nd-order polynomial. Samples are analyzed using IGOR Pro.

### Diluent

In an embodiment, the diluent comprises ≧0.1 wt. %, based on the weight of the diluent, of an aliphatic paraffin having (i) an average carbon number in the range of C₂₀ to C₁₅₀₀ and (ii) ≧1 pendent group having a carbon number ≧C₄ per six backbone carbon atoms. In an embodiment, the diluent comprises ≧0.01 wt. % of the aliphatic paraffin, e.g., ≧10.0 wt. %, such as ≧50.0 wt. % or ≧90.0 wt. % of the aliphatic paraffin, based on the weight of the diluent. The number of pendent groups having a carbon number ≧C₄ per six backbone carbon atoms can be determined using conventional methods, e.g., nuclear magnetic resonance and variants thereof, but the invention is not limited thereto. Optionally, the diluent has a kinematic viscosity at 40° C. in the range of 5.0 mm²/sec to 5.0×10² mm²/sec, such as 10.0 mm²/sec to 3.0×10² mm²/sec, e.g., 20.0 mm²/sec to 2.0×10² mm²/sec (cSt). Optionally, the aliphatic hydrodarbon further comprises ≦10.0 wt. % of pendent groups having a carbon number of C₂ or C₃, e.g., ≦5.0 wt. %, such as ≦1.0 wt. % based on the weight of the aliphatic hydrocarbon. The diluent can further comprise a second hydrocarbon. When used, the second hydrocarbon can be a hydrocarbon mixture.

Polymer-diluent mixing is improved when the diluent is compatible with the polymer of the polymer-diluent mixture. Compatibility can be determined using Dynamic Mechanical Thermal Analysis (DMTA) under the conditions specified in U.S. Pat. No. 7,795,366. A compatible diluent is one that exhibits no significant change in the number of peaks in the DMTA curve of the polymer-diluent mixture as compared with the DMTA curve of the neat polymer.

In an embodiment, the diluent comprises ≦1.0 wt. % based on the weight of the diluent of molecules having functional groups, such as those containing functional groups having one or more of a hydroxide, aryls and substituted aryls, alkoxys, carboxylates, esters, or acrylates, carboxyl functionality. In an embodiment, the diluent comprises ≦1.0 wt. % based on the weight of the diluent of molecules having an appreciable amount of heteroatoms, such as one or more of halogen, oxygen, nitrogen, and sulfur; or groups containing such heteroatoms.

In an embodiment, the diluent does not contain molecules having an appreciable amount of unsaturation, e.g., an appreciable amount of olefinic unsaturation. The term “appreciable amount” in this context means that the diluent contains ≦1.0% of carbon atoms having unsaturated bonds (e.g., olefinic bonds), based on the total number of carbon atoms in the diluent, e.g., ≦0.01%, such as ≦0.001%. The percentage of carbon atoms having unsaturated bonds can be determined by methods described in U.S. Pat. No. 7,795,366.

The aliphatic paraffin and the optional second hydrocarbon will now be described in more detail. Although the aliphatic paraffin is described in terms of PAO, the invention is not limited thereto, and this description is not meant to foreclose other embodiments within the broader scope of the invention.

### The Aliphatic Paraffin

In an embodiment, the diluent comprises aliphatic paraffin having (i) an average carbon number in the range of C₂₀ to C₁₅₀₀ and (ii) ≧1 pendent group having a carbon number ≧C₄ per six backbone carbon atoms. Optionally, the aliphatic paraffin comprises a mixture of (i) molecules which are PAO (or a mixture thereof) and (ii) molecules which are aliphatic paraffin but are not PAO. For example, the aliphatic paraffin can comprise ≧75.0 wt. %, e.g., ≧95.0 wt. %, such as ≧99.0 wt. % of one or more PAO, based on the weight of the aliphatic paraffin When the aliphatic paraffin comprises PAO, the PAO can have, e.g., an Mn≧400.0 such as ≧750.0, e.g., in the range of from about 8.0×10² to 2.1×10³, such as from about 8.5×10² to about 2.0×10³. Optionally, the PAO comprises oligomers of at least dimer order, the oligomers being derived from one or more of 1-butene, 1-pentene, 1-hexene, 1-heptene, 1-octene, 1-nonene, 1-decene, 1-undecene, or 1-dodecene. For example, the aliphatic paraffin can comprise repeating units derived from, e.g., a dimer of 1-butene and 1-hexene, a dimer of 1-hexene, and/or a dimer of 1-decene. In other words, the specified aliphatic paraffin can comprise e.g., repeating units derived from dimers of (a) a first α-olefin having ≧6 carbon atoms and (b) a second α-olefin having ≧4 carbon atoms.

In one embodiment, the PAO comprises ≧50.0 wt. % based on the weight of the PAO of oligomers derived from C₈ to C₁₂ linear α-olefin (e.g., at least one of 1-octene, 1-nonene, 1-decene, 1-undecene and 1-dodecene, 1-decene, 1-undecene or 1-dodecene). In an embodiment, ≧90.0 wt. % of the aliphatic paraffin, e.g., ≧95.0 wt. %, such as ≧90.9 wt. % (based on the weight of the aliphatic paraffin) comprises PAO (including mixtures of two or more PAOs).

In an embodiment, the PAO has a kinematic viscosity (“KV” as measured by ASTM D 445) (i) at 100° C.≧ about 4.0 cSt (mm²/sec), such as ≧5.0 mm²/sec e.g., in the range of 5.0 mm²/sec to 10.0 mm²/sec; and/or (ii) at 40° C.≧ about 20.0 mm²/sec, such as ≧30.0 mm²/sec, e.g., in the range of 40.0 mm²/sec to 60.0 mm²/sec. In an embodiment, the PAO has a viscosity index (“VI” as measured by ASTM D 2270)≧125.0, e.g., ≧ about 130.0, such as ≧140.0. In an embodiment, the PAO has a pour point (as measured by ASTM D 97)≦−30.0° C., e.g., ≦ about −40.0° C., such as ≦−50.0° C., optionally in the range of −40.0° C. to −60.0° C.

Optionally, the PAO has an average carbon number in the range of C₄₀ to C₁₀₀₀, e.g., C₅₀ to C₇₅₀ such as C₅₀ to C₅₀₀. In one embodiment, the PAO is derived from 1-decene, e.g., the PAO can be a mixture of dimers, trimers, tetramers, and pentamers (and higher order) derived from 1-decene. Such PAOs are described more particularly in, for example, U.S. Pat. No. 5,171,908, U.S. Pat. No. 5,783,531 and in SYNTHETIC LUBRICANTS AND HIGH-PERFORMANCE FUNCTIONAL FLUIDS, pgs. 1-52 (Leslie R. Rudnick & Ronald L. Shubkin, ed. Marcel Dekker, Inc., 1999).

In an embodiment, the aliphatic paraffin is a mixture of oligomers of C₈ to C₁₂ linear α-olefins (e.g., is a mixture of PAOs derived from one or more of 1-octene, 1-nonene, 1-decene, 1-undecene, or 1-dodecene), wherein the mixture has one or more of a density ≦0.850; an Mn≧750.0 (e.g., ≧850.0); an MWD≦4.0, e.g., in the range of from about 1.2 to about 3.0, a viscosity index ≧125.0; and a kinematic viscosity ≧45.0 mm²/sec at 40° C., e.g., ≧50.0 mm²/sec at 40° C.; a kinematic viscosity ≧5.0 mm²/sec at 100° C.; a pour point≦−30.0° C.; and a flash point≧245° C.

The PAO can be one or more of, e.g., commercially available PAOs such as SHF and SuperSyn PAOs (ExxonMobil Chemical Company, Houston Tex.), e.g., those described in U.S. Pat. Nos. 7,795,366 and 7,271,209 (which is incorporated by reference herein in its entirety), such as SHF-61/63, SHF-82/83, and SHF-101, and combinations thereof. In other embodiments, the PAO can be at least one PAO sold under the trade names Synfluid™ available from ChevronPhillips Chemical Co. in Pasadena Tex., Durasyn™ available from BP Amoco Chemicals in London England, Nexbase™ available from Fortum Oil and Gas in Finland, Synton™ available from Crompton Corporation in Middlebury, Conn., USA, EMERY™ available from Cognis Corporation in Ohio, USA, or Lucant™ available from Mitsui Chemicals America, Inc.

In yet another embodiment, the aliphatic paraffin comprises ≧1.0 wt. % of first repeating units based on the weight of the aliphatic paraffin, the aliphatic paraffin having an average carbon number in the range of C₂₀ to C₁₅₀₀; wherein the first repeating units comprise ≧1 pendent group having a carbon number ≧C₄ per six backbone carbon atoms. For example, the aliphatic paraffin can comprise (a) ≧10.0 wt. %, e.g., ≧50.0 wt. %, such as ≧90.0 wt. % of the first repeating units and (b)≦90.0 wt. %, e.g., ≦50.0 wt. %, such as ≦10.0 wt. % of second repeating units, the second repeating units being derived, e.g., from ethylene and/or propylene; wherein the weight percents are based on the weight of the aliphatic paraffin. Optionally, the sequences of first and second repeating units are randomly-distributed in the aliphatic paraffin, or organized in blocks.

### The Second Hydrocarbon

In an embodiment, the diluent further comprises ≦99.9 wt. %, e.g., ≦50.0 wt. %, such as ≦10.0 wt. % (based on the weight of the diluent) of a second hydrocarbon, the second hydrocarbon (which can be a mixture of hydrocarbons) having (i) an average carbon number (i.e., average number of carbon atoms based on the total number of carbon atoms in the second hydrocarbon) in the range of C₆ to C₁₅₀₀ and (ii) ≦1.0 wt. %, e.g., ≦0.1 wt. %, such as ≦0.01 wt. %, based on the weight of the second hydrocarbon, of repeating units having ≧1 pendent group having a carbon number ≧C₄ per six backbone carbon atoms. In an embodiment, the second hydrocarbon comprises pendent groups having an average carbon number ≧C₃ in an amount≦0.1 wt. %, based on the weight of the second hydrocarbon. Examples of the second hydrocarbon include one or more aliphatic or cyclic hydrocarbon, such as nonane, decane, decalin and paraffin oil (e.g., white oil or other low-aromatic content paraffin oil); and phthalic acid ester such as dibutyl phthalate and dioctyl phthalate.

In an embodiment, the second hydrocarbon is paraffin (or mixture thereof) having an average carbon number in the range of about C₆ to about C₁₀₀₀, e.g., in the range of about C₁₀ to about C₅₀₀, such as about C₁₂ to about C₁₅₀; wherein the paraffin does not contain ≧0.01 wt. % of pendent groups having a carbon number ≧C₃. Optionally, the second hydrocarbon is a paraffin mixture having an isoparaffin:n-paraffin ratio in the range of from about 0.5:1 to about 9:1, e.g., from about 1:1 to about 4:1. Optionally, the isoparaffins in the paraffin mixture contain ≧50.0 wt. %, e.g., ≧70.0 wt. %, such as ≧90.0 wt. % mono-methyl species based on the weight of the isoparaffins in the mixture, e.g., 2-methyl, 3-methyl, 4-methyl, ≧5-methyl or the like, with ≦10.0% of branches having a carbon number >C₁ based on the total number of branches in the isoparaffin. Optionally, the isoparaffins of the paraffin mixture contain ≧90.0 wt. % of mono-methyl species, based on the total weight of the isoparaffins in the paraffin mixture.

The second hydrocarbon can be, e.g., a white oil having a KV at 40° C. in the range of 40.0 mm²/sec (cSt) to 100.0 mm²/sec (cSt), a pour point≦0° C., and a density in the range of 0.850 to 0.890 g/cm³. Suitable second hydrocarbons include, e.g., Primol™ available from ExxonMobil or P-260T™ available from Moresco, and those described in U.S. Pat. Pub. Nos. 2008/0057388 and 2008/0057389, both of which are incorporated by reference in their entirety.

It has been observed that when the diluent comprises ≧0.1 wt. %, based on the weight of the diluent of an aliphatic paraffin having (i) an average carbon number in the range of C₂₀ to C₁₅₀₀ and (ii) ≧1 pendent group having a carbon number ≧C₄ per six backbone carbon atoms, an improved process results for producing the microporous membrane (e.g., a more efficient wet process utilizing diluent during extrusion) and in a microporous membrane having improved properties. For example, using such a diluent generally results in at least one of the following improvements:

Fewer deposits on the membrane process equipment: The diluent has improved thermal and thermo-oxidative stability relative to conventional liquid diluent. This oxidative stability is particularly beneficial in processes where the diluent is recycled after separation from the membrane for re-use in the process since at least a portion of the diluent will be exposed to repeated high severity (temperature, shear, etc.) in the process.
Improved control of membrane properties: The diluent has an improved solubility parameter and solubility parameter distribution compared to conventional diluents, thereby enabling the production of membranes having a desirable balance of porosity, permeability, and strength.
Improved viscosity-temperature and viscosity-shear performance: More uniform polymer-diluent extrusion can be achieved over a broader compositional range even under relatively severe shear and temperature conditions.
More rapid drying: The exceptionally narrow MWD and CD of the PAO, as well as the more favorable partitioning between polyolefin and washing solvent, results in more rapid drying of the membrane after the diluent has been removed.

In an embodiment, where the aliphatic paraffin is a PAO having an Mn ≧about 850 and having an MWD in the range of from about 1.2 to about 3.0, there is a further process improvement resulting from fewer byproducts (e.g., smoke) forming from the oxidation of relatively low molecular weight ends in the diluent. In addition to improved mixing and extrusion (resulting in a more uniform membrane), using such a diluent also results in improved diluent removal and improved membrane drying when solvent-extraction is used.

Methods for producing the membrane from the polymer and diluent will now be described in more detail. Although the production method is described in terms of membranes produced by removing diluent from a sheet produced by extrusion, the invention is not limited thereto, and this description is not meant to foreclose other embodiments within the broader scope of the invention.

### Production Method of Microporous Polyolefin Membrane

In an embodiment, the microporous membranes can be produced by combining polymer and diluent, wherein the diluent comprises the aliphatic paraffin (the polymer, diluent, and aliphatic paraffin being as specified above), to form a polymer-diluent mixture and then extruding the mixture to form an extrudate in the form of a sheet. The polymer and diluent can be combined, e.g., by dry blending or melt mixing, and the mixture can further comprise additional components such as antioxidants, inorganic fillers, etc. After extrusion, at least a portion of the diluent is removed from the extrudate to form the microporous membrane. For example, a blend of PE can be combined with the diluent to form a mixture, with the mixture being extruded to form a monolayer membrane. Additional layers can be applied to the extrudate, if desired, e.g., to provide the finished membrane with a low shutdown functionality. In other words, monolayer extrudates or monolayer microporous membranes can be laminated or coextruded to form multilayered membranes.

The process for producing the membrane optionally comprises stretching the extrudate in at least one planar direction before diluent removal, and, optionally, stretching the membrane in at least one planar direction after diluent removal. In an embodiment, the process for producing the membrane further comprises additional optional steps for, e.g., removing at least a portion of any remaining volatile species from the membrane at any time after diluent removal, subjecting the membrane to a thermal treatment (such as heat setting or annealing) before or after diluent removal, a hot solvent treatment step, a cross-linking step (e.g., using ionizing radiation), a hydrophilic treatment step, etc. Such optional steps are described in PCT Patent Publication No. WO 2008/016174, which is incorporated by reference herein in its entirety. Neither the number nor order of the optional steps is critical. Multilayer membranes are within the scope of the invention. These can be produced from first and second mixtures of polymer and diluent by extruding the mixtures through multilayer dies or by lamination (of the layered polymer-diluent mixtures and/or finished membranes), for example.

### Producing the Polymer-Diluent Mixture

In an embodiment, the polymer and diluent are combined in, e.g., a batch mixer, a mixer extruder, etc., to produce the polymer-diluent mixture. In another embodiment, the polymer is a mixture (as described above, e.g., one or more of PE such as at least one of PE1, PE2, PE3, or PE4; polypropylene; polymethylpentene, etc.) which can be combined to form a polymer blend and the blend is combined with the diluent to produce the polymer-diluent mixture. Mixing can be conducted, e.g., in an extruder such as a reaction extruder. Such extruders include, without limitation, twin-screw extruders, ring extruders, and planetary extruders. Optional species can be included in the polymer-diluent mixture, e.g., fillers, antioxidants, stabilizers, and/or heat-resistant polymers. The type and amounts of such optional species can be the same as described in PCT Patent Publication Nos. WO 2007/132942, WO 2008/016174, and WO 2008/140835, all of which are incorporated by reference herein in their entirety.

In an embodiment, the diluent comprises ≧0.01 wt. % (based on the weight of the diluent) of aliphatic paraffin having (i) an average carbon number in the range of C₂₀ to C₁₅₀₀ and (ii) ≧1 pendent group having a carbon number ≧C₄ per six backbone carbon atoms. The aliphatic paraffin can comprise, e.g., ≧75.0 wt. %, e.g., ≧95.0 wt. %, such as ≧99.0 wt. % of one or more PAO based on the weight of the aliphatic paraffin. The PAO can be the same as that specified above. For example, the aliphatic paraffin can comprise ≧75.0 wt. %, based on the weight of the aliphatic paraffin, of PAO that (i) is derived from 1-decene, e.g., a mixture of dimers, trimers, tetramers, and pentamers (and higher order) derived from 1-decene; (ii) has an average carbon number in the range of C₅₀ to C₅₀₀; and (iii) has one or more the following properties: a density ≦0.850; an Mn≧750.0; a viscosity index ≧125.0; a kinematic viscosity ≧50.0 mm²/sec at 40° C.; a kinematic viscosity ≧5.0 mm²/sec at 100° C.; a pour point≦−30° C.; and a flash point≧245° C. The diluent is generally compatible with the polymers used to produce the extrudate. Optionally, the diluent further comprises a second hydrocarbon as specified above, e.g., a second hydrocarbon capable of forming a single phase in conjunction with the polymer and the aliphatic hydrocarbon at the extrusion temperature.

In an embodiment, the blended polymer in the polymer-diluent mixture comprises ≧45.0 wt. %, e.g., in the range of 45.0 wt. % to 95.0 wt. % of PE1; ≦30.0 wt. % PE2, ≦30.0 wt. % PE3, ≧5.0 wt. %, e.g., 5.0 wt. % to 55.0 wt. % of PE4 based on the weight of the blended polymer in the polymer-diluent mixture. Optionally, the amount of PE1 is in the range of 50.0 wt. % to 65.0 wt. % and the amount of PE4 is in the range of 35.0 wt. % to 50.0 wt. %. In another embodiment, the blended polymer in the polymer-diluent mixture comprises, e.g., ≧45.0 wt. %, e.g., in the range of 45.0 wt. % to 95.0 wt. % of PE2; ≦30.0 wt. % PE1, ≦30.0 wt. % PE3, ≧5.0 wt. %, e.g., 5.0 wt. % to 55.0 wt. % of PE4 based on the weight of the blended polymer in the polymer-diluent mixture. Optionally, the amount of PE2 is in the range of 65.0 wt. % to 95.0 wt. % and the amount of PE4 is in the range of 5.0 wt. % to 35.0 wt. %.

In an embodiment, the polymer-diluent mixture during extrusion is exposed to a temperature in the range of 140° C. to 250° C., e.g., 210° C. to 230° C. In an embodiment, the polymer-diluent mixture comprises (a) polymer in an amount≧5.0 wt. %, e.g., in the range of from 15.0 wt. % to 45.0 wt. % and (b) diluent in an amount≧50.0 wt. %, e.g., 55.0 wt. % to 85.0 wt. %; the weight percents being based on the weight of the polymer-diluent mixture. For example, the amount of polymer can be in the range of about 20.0 wt. % to about 40.0 wt. %.

### Producing the Extrudate

In an embodiment, the polymer-diluent mixture is conducted from an extruder through a die to produce the extrudate. The extrudate should have an appropriate thickness to produce, after the stretching steps, a final membrane having the desired thickness (generally ≧1.0 μm). For example, the extrudate can have a thickness in the range of about 0.1 mm to about 10.0 mm, or about 0.5 mm to 5.0 mm. The thickness of the extrudate is not critical, and is selected to provide a finished membrane having a final membrane thickness (after stretching)≦200.0 μm.

Extrusion is generally conducted with the polymer-diluent mixture in the molten state. When a sheet-forming die is used, the die lip is generally heated to an elevated temperature, e.g., in the range of 140° C. to 250° C. Suitable process conditions for accomplishing the extrusion are disclosed in PCT Patent Publication Nos. WO 2007/132942 and WO 2008/016174.

If desired, the extrudate can be exposed to a temperature in the range of about 10° C. to about 45° C. to form a cooled extrudate. Cooling rate is not particularly critical. For example, the extrudate can be cooled at a cooling rate of at least about 30° C./minute until the temperature of the extrudate (the cooled temperature) is approximately equal to the extrudate's gelation temperature (or lower). Process conditions for cooling can be the same as those disclosed in PCT Patent Publication Nos. WO 2007/132942, WO 2008/016174, and WO 2008/140835, for example.

### Stretching the Extrudate (Upstream Stretching)

The extrudate or cooled extrudate can be stretched in at least one direction. The extrudate can be stretched by, for example, a tenter method, a roll method, an inflation method or a combination thereof, as described in PCT Patent Publication No. WO 2008/016174, for example. The stretching may be conducted monoaxially or biaxially, though the biaxial stretching is preferable. In the case of biaxial stretching, any of simultaneous biaxial stretching, sequential stretching or multi-stage stretching (for instance, a combination of the simultaneous biaxial stretching and the sequential stretching) can be used, though simultaneous biaxial stretching is preferable. When biaxial stretching is used, the amount of magnification need not be the same in each stretching direction.

The stretching magnification factor can be, for example, ≧2.0 fold, optionally 3.0 to 30.0 fold in the case of monoaxial stretching. In the case of biaxial stretching, the stretching magnification can be, for example, ≧3.0 fold in any direction, e.g., ≧5.0 fold, such as ≧9.0 fold, or ≧16 fold or ≧25 fold or more, in area magnification. An example for this stretching step would include stretching from about 9.0 fold to about 49 fold in area magnification. Again, the amount of stretch in either direction need not be the same. The magnification factor operates multiplicatively on film size. For example, a film having an initial width (TD) of 2.0 cm that is stretched in TD to a magnification factor of 4 fold will have a final width of 8.0 cm.

The stretching can be conducted while exposing the extrudate to a temperature (the upstream orientation temperature) in the range of from about 80.0° C. to about 130.0° C., e.g., in the range of Tcd to Tm, where Tcd and Tm are defined as the crystal dispersion temperature and melting point of the polymer having the lowest melting point among the polymers used to produce the extrudate (generally the PE such as PE1, PE2, or PE3). The crystal dispersion temperature is determined by measuring the temperature characteristics of dynamic viscoelasticity according to ASTM D 4065. In an embodiment where Tcd is in the range of about 90° C. to about 100° C., the stretching temperature can be from 90.0° C. to 122.0° C.; e.g., from about 110.0° C. to 120.0° C., such as from 113.0° C. to 117.0° C. While not wishing to be bound by any theory or model, it is believed that when the membrane comprises polyethylene, the best balance of membrane air permeability and MD heat shrinkage is obtained when the stretching temperature is in the range of 112° C. to 115° C.

When the sample (e.g., the extrudate, dried extrudate, membrane, etc.) is exposed to an elevated temperature, this exposure can be accomplished by heating air and then conveying the heated air into proximity with the sample. The temperature of the heated air, which is generally controlled at a set point equal to the desired temperature, is then conducted toward the sample through a plenum for example. Other methods for exposing the sample to an elevated temperature, including conventional methods such as exposing the sample to a heated surface, infra-red heating in an oven, etc., can be used with or instead of heated air.

### Diluent Removal

In an embodiment, at least a portion of the diluent is removed (or displaced) from the stretched extrudate to form the membrane. A displacing (or “washing”) solvent can be used to remove (wash away, or displace) the diluent, as described in PCT Patent Publication No. WO 2008/016174, for example.

In an embodiment, at least a portion of any remaining volatile species (e.g., washing solvent) is removed from the membrane after diluent removal. Any method capable of removing the washing solvent can be used, including conventional methods such as heat-drying, wind-drying (moving air), etc. Process conditions for removing volatile species such as washing solvent can be the same as those disclosed in PCT Patent Publication No. WO 2008/016174, for example.

The relatively narrow molecular weight distribution of the aliphatic hydrocarbon (particularly PAO) compared to conventional diluents leads to improvements in the ability to separate the diluent (e.g., by distillation) from other diluent components and the washing solvent for recovery and recycle.

### Stretching the Membrane (Downstream Stretching)

The membrane can be stretched (also called “dry stretching”, “second stretching”, or “dry orientation” since at least a portion of the diluent has been removed or displaced) in at least TD. Before dry stretching, the membrane has an initial size in MD (a first dry length) and an initial size in TD (a first dry width). As used herein, the term “first dry width” refers to the size of the membrane in TD prior to the start of dry stretching. The term “first dry length” refers to the size of the membrane in MD prior to the start of dry stretching. Tenter stretching equipment of the kind described in WO Patent Publication No. 2008/016174 can be used, for example. Optionally, the downstream stretching is conducted to achieve a magnification factor ≧1.2 in at least one direction.

The membrane can be stretched in MD from the first dry length to a second dry length that is larger than the first dry length by a magnification factor (the “MD dry stretching magnification factor”) in the range of from about 1.0 to about 1.6, e.g., in the range of 1.1 to 1.5. When TD dry stretching is used, the membrane can be stretched in TD from the first dry width to a second dry width that is larger than the first dry width by a magnification factor (the “TD dry stretching magnification factor”). Optionally, the TD dry stretching magnification factor is ≦the MD dry stretching magnification factor. The TD dry stretching magnification factor can be in the range of from about 1.1 to about 1.6, e.g., about 1.2 to 1.5. The dry stretching (also called re-stretching since the diluent-containing extrudate has already been stretched) can be sequential or simultaneous in MD and TD. When biaxial dry stretching is used, the dry stretching can be simultaneous in MD and TD or sequential. When the dry stretching is sequential, generally MD stretching is conducted first, followed by TD stretching.

The dry stretching can be conducted while exposing the membrane to a temperature (the downstream stretching temperature)≦Tm, e.g., in the range of from about Tcd-20° C. to Tm. In a form, the stretching temperature is conducted with the membrane exposed to a temperature in the range of from about 70.0° C. to about 135.0° C., for example from about 110.0° C. to about 132.0° C., such as from about 120.0° C. to about 124.0° C.

In a embodiment, the MD stretching magnification is about 1.0; the TD dry stretching magnification is ≦1.6, e.g., in the range of from about 1.1 to about 1.5, such as 1.2 to 1.5; and the dry stretching is conducted while the membrane is exposed to a temperature in the range of about 120° C. to about 124° C.

The stretching rate is preferably 3%/second or more in the stretching direction (MD or TD), and the rate can be independently selected for MD and TD stretching. The stretching rate is preferably 5%/second or more, more preferably 10%/second or more, e.g., in the range of 5%/second to 25%/second. Though not particularly critical, the upper limit of the stretching rate is preferably 50%/second to prevent rupture of the membrane.

### Controlled Reduction of the Membrane's Width

Following the downstream stretching, the membrane can be subjected to a controlled reduction in width from the second dry width to a third dry width, the third dry width being in the range of from 0.9 times the first dry width to about 1.5 times larger than the first dry width. Optionally, the second dry width is in the range of 1.25 to 1.35 of the first dry width and the third dry width is in the range of 0.95 to 1.05 of the first dry width. The width reduction is generally conducted while the membrane is exposed to a temperature ≧Tcd −30° C., but no greater than Tm, e.g., in the range of from about 70.0° C. to about 135.0° C., for example from about 110.0° C. to about 132.0° C., such as from about 120.0° C. to about 124.0° C.

Although the temperature can be the same as the temperature to which the membrane is exposed during downstream stretching, this is not required, and in one embodiment the temperature to which the membrane is exposed during controlled width reduction is ≧1.01 times the temperature to which the membrane was exposed during downstream stretching, e.g., in the range of 1.05 times to 1.1 times. In a form, the decreasing of the membrane's width is conducted while the membrane is exposed to a temperature that ≦124.0° C., the third dry width is in the range of from 0.95 to 1.05 of the first dry width.

### Heat Set

Optionally, the membrane is thermally treated (e.g., heat-set) at least once following diluent removal, e.g., after dry stretching, the controlled width reduction, or both. It is believed that heat-setting stabilizes crystals and makes uniform lamellas in the membrane. In a form, the heat setting is, conducted while exposing the membrane to a temperature in the range Tcd to Tm, e.g., in the range of from about 70.0° C. to about 135.0° C., for example from about 110.0° C. to about 132.0° C., such as from about 120.0° C. to about 124.0° C. Although the heat set temperature can be the same as the downstream stretching temperature, this is not required. In one embodiment the temperature to which the membrane is exposed during heat setting is ≧1.01 times the temperature to which the membrane was exposed during controlled width reduction, e.g., in the range of 1.05 times to 1.1 times. Generally, the heat setting is conducted for a time sufficient to form uniform lamellas in the membrane, e.g., a time ≦1000 seconds, e.g., in the range of 1 to 600 seconds. In a form, the heat setting is operated under conventional heat-set “thermal fixation” conditions. The term “thermal fixation” refers to heat-setting carried out while maintaining the length and width of the membrane substantially constant, e.g., by holding the membrane's perimeter with tenter clips during the heat setting.

Optionally, an annealing treatment can be conducted after the heat-set step. The annealing is a heat treatment with no load applied to the membrane, and can be conducted by using, e.g., a heating chamber with a belt conveyer or an air-floating-type heating chamber. The annealing may also be conducted continuously after the heat-setting with the tenter slackened. During annealing, the membrane can be exposed to a temperature in the range of Tm or lower, e.g., in the range from about 60° C. to about Tm −5° C. Annealing is believed to provide the microporous membrane with improved permeability and strength.

Optional heated roller, hot solvent, crosslinking, hydrophilizing, and coating treatments can be conducted, if desired, e.g., as described in PCT Patent Publication No. WO 2008/016174.

### Microporous Membrane Composition and Properties

In an embodiment, the membrane is microporous and permeable to liquid (aqueous and non-aqueous) at atmospheric pressure. Thus, the membrane can be used as a battery separator, filtration membrane, etc. The membrane is particularly useful as a BSF for a secondary battery, such as a nickel-hydrogen battery, nickel-cadmium battery, nickel-zinc battery, silver-zinc battery, lithium-ion battery, lithium-ion polymer battery, etc.

In an embodiment, the invention relates to lithium-ion secondary batteries containing BSF comprising the thermoplastic film. Such batteries are described in PCT Patent Publication No. WO 2008/016174, which is incorporated herein by reference in its entirety.

In an embodiment, the membrane is microporous and comprises (i)≧90.0 wt. % polyolefin based on the weight of the membrane, e.g., ≧99.0 wt. % polyethylene and (ii)≧0.01 wt. %, e.g., ≧0.10 wt. %, such as ≧1.0 wt. % of the aliphatic paraffin based on the weight of the membrane, e.g., the aliphatic paraffin can comprise diluent remaining in the membrane as a result of incomplete diluent removal during processing. In another embodiment, the diluent removal is substantially complete, e.g., the membrane comprises ≦1.0 wt. %, e.g., ≦0.10 wt. %, such as ≦0.01 wt. % of the aliphatic paraffin based on the weight of the membrane. The aliphatic paraffin (as described in detail above) comprises, e.g., one or more of those (a) having (i) an average carbon number in the range of C₂₀ to C₁₅₀₀ and (ii) ≧1 pendent group having a carbon number ≧C₄ per six backbone carbon atoms; (b) having (i) an average carbon number in the range of C₂₀ to C₁₅₀₀ and (ii) first repeating units derived from one or more oligomers of a first α-olefin; wherein the first α-olefin has ≧6 carbon atoms; or (c) having ≧1.0 wt. % of first repeating units, based on the weight of the aliphatic paraffin and (ii) having an average carbon number in the range of C₂₀ to C₁₅₀₀; wherein the first repeating units comprise ≧1 pendent group having a carbon number ≧C₄ per six backbone carbon atoms.

The membranes of the invention, e.g., those produced by an extrusion process utilizing the specified aliphatic paraffin, may have one or more of the following properties.

### Thickness

In an embodiment, the thickness of the final membrane is ≦1.0×10² μm, e.g., in to the range of about 1.0 μm to about 1.0×10² μm. For example, a monolayer membrane can have a thickness in the range of about 1.0 μm to about 30.0 μm, and a multilayer membrane can have a thickness in the range of 7.0 μm to 30.0 μm, but these values are merely representative. The membrane's thickness can be measured, e.g., by a contact thickness meter at 1 cm longitudinal intervals over the width of 10 cm, and then averaged to yield the membrane thickness. Thickness meters such as a Model RC-1 Rotary Caliper, available from Maysun, Inc., 746-3 Gokanjima, Fuji City, Shizuoka, Japan 416-0946 or a “Litematic” available from Mitsutoyo Corporation, are suitable. Non-contact thickness measurement methods are also suitable, e.g., optical thickness measurement methods. In an embodiment, the membrane has a thickness ≦25.0 μm.

### Porosity ≧20.0%

The membrane's porosity is measured conventionally by comparing the membrane's actual weight to the weight of an equivalent non-porous membrane of 100% polymer (equivalent in the sense of having the same polymer composition, length, width, and thickness). Porosity is then determined using the formula: Porosity %=100×(w2−w1)/w2, where “w1” is the actual weight of the membrane, and “w2” is the weight of an equivalent non-porous membrane (of the same polymers) having the same size and thickness. In a form, the membrane's porosity is in the range of 20.0% to 80.0%, e.g., in the range of 25.0% to 85.0%.

Normalized Air Permeability ≦50.0 Seconds/100 cm³/μm

In an embodiment, the membrane has a normalized air permeability ≦50.0 seconds/100 cm³/μm (as measured according to JIS P8117), such as ≦40.0 seconds/100 cm³/μm, e.g., ≦30.0 seconds/100 cm³/μm. Optionally, the membrane has a normalized air permeability in the range of 10.0 seconds/100 cm³/μm to 30.0 seconds/100 cm³/μm. Since the air permeability value is normalized to the value for an equivalent membrane having a film thickness of 1.0 μm, the membrane's air permeability value is expressed in units of “seconds/100 cm³ μm”. Optionally, the membrane's normalized air permeability is in the range of from about 1.0 seconds/100 cm³/μm to about 25 seconds/100 cm³/μm. Normalized air permeability is measured according to JIS P8117, and the results are normalized to the permeability value of an equivalent membrane having a thickness of 1.0 μm using the equation A=1.0 μm*(X)/T₁, where X is the measured air permeability of a membrane having an actual thickness T₁ and A is the normalized air permeability of an equivalent membrane having a thickness of 1.0 μm.

Normalized Pin Puncture Strength ≧1.0×10² mN/μm

The membrane's pin puncture strength is expressed as the pin puncture strength of an equivalent membrane having a thickness of 1.0 μm and a porosity of 50% [mN/μm]. Pin puncture strength is defined as the maximum load measured at ambient temperature when the membrane having a thickness of T₁ is pricked with a needle of 1 mm in diameter with a spherical end surface (radius R of curvature: 0.5 mm) at a speed of 2 mm/second. The pin is puncture strength (“S”) is normalized to the pin puncture strength value of an equivalent membrane having a thickness of 1.0 μm and a porosity of 50% using the equation S₂=[50%*20 μm*(S₁)]/[T₁*(100%−P)], where S₁ is the measured pin puncture strength, S₂ is the normalized pin puncture strength, P is the membrane's measured porosity, and T₁ is the average thickness of the membrane. Optionally, the membrane's normalized pin puncture strength is ≧1.5×10² mN/μm, e.g., ≧2.0×10² mN/μm, such as in the range of 1.0×10² mN/μm to 2.5×10² mN/μm.

### Shutdown Temperature ≦140.0° C.

The microporous membrane's shutdown temperature is measured by the method disclosed in PCT Patent Publication No. WO 2007/052663, which is incorporated by reference herein in its entirety. According to this method, the microporous membrane is exposed to an increasing temperature (5° C./minute beginning at 30° C.) while measuring the membrane's air permeability. The microporous membrane's shutdown temperature is defined as the temperature at which the microporous membrane's air permeability (Gurley Value) first exceeds 1.0×10⁵ seconds/100 cm³. For the purpose of measuring membrane meltdown temperature and shutdown temperature, air permeability can be measured according to JIS P8117 using, e.g., an air permeability meter (EGO-1T available from Asahi Seiko Co., Ltd.). In an embodiment, the shutdown temperature is ≦140.0° C. or ≦130.0° C., e.g., in the range of 128.0° C. to 133.0° C.

### Meltdown Temperature (as Measured by Membrane Rupture)≧145.0° C.

In an embodiment, the microporous membrane has a meltdown temperature ≧145.0° C., such as ≧155.0° C., e.g., ≧200.0° C. Optionally, the membrane has a meltdown temperature in the range of about 145.0° C. to about 220.0° C. Meltdown temperature can be measured as follows. A sample of the microporous membrane measuring 5 cm×5 cm is fastened along its perimeter by sandwiching the sample between metallic blocks each having a circular opening of 12 mm in diameter. The blocks are then positioned so the plane of the membrane is horizontal. A tungsten carbide ball of 10 mm in diameter is placed on the microporous membrane in the circular opening of the upper block. Starting at 30° C., the membrane is then exposed to an increasing temperature at a rate of 5° C./minute. The temperature at which the microporous membrane is ruptured by the ball is defined as the membrane's meltdown temperature.

### 105° C. TD Heat Shrinkage 10.0%

In an embodiment, the membrane has a TD heat shrinkage at 105.0° C. ≦10.0%, such as ≦5.0%, e.g., in the range of from about 1.0% to about 5.0%. Optionally, the membrane has an MD heat shrinkage at 105.0° C. 10.0%, e.g., in the range of about 1.0% to about 10.0%.

The membrane's heat shrinkage in orthogonal planar directions (e.g., MD or TD) at 105.0° C. (the “105.0° C. heat shrinkage”) is measured as follows: (i) measure the size of a test piece of microporous membrane at 23.0° C. in both MD and TD, (ii) expose the test piece to a temperature of 105.0° C. for 8 hours with no applied load, and then (iii) measure the size of the membrane in both MD and TD. The heat (or “thermal”) shrinkage in either the MD or TD can be obtained by dividing the result of measurement (i) by the result of measurement and (ii) expressing the resulting quotient as a percent.

### Particular Embodiments

In a particular embodiment, the membrane comprises ≧75.0 wt. %, e.g., ≧90.0 wt. %, such as ≧95.0 wt. % polyethylene (the first component) and ≧0.01 wt. % of aliphatic paraffin (the second component), the weight percents being based on the weight of the membrane; the aliphatic paraffin having an average carbon number in the range of C₂₀ to C₁₅₀₀ and at least one of the following properties: (i)≧1 pendent group having a carbon number ≧C₄ per six backbone carbon atoms; (ii) first repeating units derived from one or more oligomers of a first α-olefin; wherein the first α-olefin has ≧6 carbon atoms; or (iii) having ≧1.0 wt. % of first repeating units based on the weight of the aliphatic paraffin, wherein the first repeating units comprise ≧1 pendent group having a carbon number ≧C₄ per six backbone carbon atoms. Optionally, the aliphatic paraffin is present in the membrane in an amount as might remain following incomplete diluent extraction following extrusion of a polymer-diluent mixture, such as ≧0.1 wt. % of the aliphatic paraffin (e.g., ≧0.5 wt. %, such as ≧1.0 wt. %) based on the weight of the membrane. For example, the membrane can comprise ≧45.0 wt. %, e.g., in the range of 45.0 wt. % to 95.0 wt. % of PE1; ≦30.0 wt. % PE2, ≦30.0 wt. % PE3, ≧5.0 wt. %, e.g., 5.0 wt. % to 55.0 wt. % of PE4, and ≧0.01 wt. % of the aliphatic paraffin, the weight percents being based on the weight of the membrane. Optionally, the amount of PE1 is in the range of 50.0 wt. % to 65.0 wt. % and the amount of PE4 is in the range of 35.0 wt. % to 50.0 wt. %, based on the weight of the membrane. In another aspect, the membrane can comprise, e.g., ≧45.0 wt. %, e.g., in the range of 45.0 wt. % to 95.0 wt. % of PE2; ≦30.0 wt. % PE1; ≦30.0 wt. % PE3; ≧5.0 wt. %, e.g., 5.0 wt. % to 55.0 wt. % of PE4, and ≧0.01 wt. % of the aliphatic paraffin, the weight percents being based on the weight of the membrane. Optionally, the amount of PE2 is in the range of 65.0 wt. % to 95.0 wt. % and the amount of PE4 is in the range of 5.0 wt. % to 35.0 wt. %, based on the weight of the membrane. Optionally, any membrane of this embodiment has one or more of a thickness ≦25.0 μm, a 105° C. heat shrinkage in at least one direction ≦10.0%, a shutdown temperature ≦140.0° C., and a meltdown temperature ≧145.0° C.

In another particular embodiment, the membrane is microporous and comprises (i) 13.0 wt. % to 23.0 wt. % (based on the weight of the membrane) of PE4, the PE4 having an Mw≧1.0×10⁶, an MWD in the range of about 2.0 to about 20.0, and a Tm 134° C.; (ii) 77.0 wt. % to 87.0 wt. % (based on the weight of the membrane) of PE2, the PE2 having an Mw ≦1.0×10⁶, an MWD in the range of about 2.0 to about 20.0, an amount of terminal unsaturation 0.50 per 1.0×10⁴ carbon atoms, and a Tm 132° C.; and (iii) optionally, ≧0.01 wt. % based on the weight of the membrane (e.g., ≧0.05 wt. %, such as ≧0.1 wt. %) of the specified aliphatic paraffin. Optionally, such a membrane has at least one of the following properties: a thickness in the range of 1.0 μm to 30.0 μm; a meltdown temperature ≧140.0° C., a 105° C. TD heat shrinkage ≦10.0%, e.g., in the range of 1.0% to 8.0%; a normalized air permeability ≦30.0 seconds/100 cm³/μm, e.g., in the range of 10.0 seconds/100 cm³/μm to 20.0 seconds/100 cm³/μm; a porosity in the range 30.0% to 60.0%, and a normalized pin puncture strength ≧1.0×10² mN/μm, e.g., ≧3.0×10² mN/μm.

This invention will be described in more detail with reference to examples below without intention of restricting the scope of this invention.

### EXAMPLES

### Example 1

### Preparation of the Polymer-Diluent Mixture

A polymer-diluent mixture is prepared by combining the aliphatic paraffin (as diluent) with a polymer, the polymer being in the form of a blend of 82.0 wt. % of PE2 and 18.0 wt. % of PE4 based on the weight of the blend. The PE2 has an Mw of about 7.46×10⁵ and an MWD of about 11.8. The PE4 has an Mw of 1.9×10⁶, an MWD of 5.09, and a Tm of 136° C.

Next, 30.0 wt. % of the polymer blend and 70.0 wt. % of the aliphatic paraffin (based on the weight of the polymer-diluent mixture) are charged into a strong-blending double-screw extruder having an inner diameter of 58 mm and L/D of 42. The aliphatic paraffin (i.e., the diluent in this example) is a PAO having a specific gravity (measured at 15.6° C.) of 0.833, a kinematic viscosity (measured at 40° C.) of 48.0 mm²/sec, a viscosity index of 139, and a pour point of −48° C. The diluent is supplied to the double-screw extruder via a side feeder. Mixing is conducted at 220° C. and 200 rpm to produce the polymer-diluent mixture.

### Membrane Production

The polymer-diluent mixture is conducted from the extruder to a sheet-forming die, to form an extrudate (in the form of a sheet). The die temperature is 210° C. The extrudate is cooled by exposing it to a temperature of 20° C. The cooled extrudate is simultaneously biaxially stretched (upstream stretching) at a stretching temperature of 112.5° C. to a magnification of 5 fold in both MD and TD. The stretched extrudate is fixed to an aluminum frame of 20 cm×20 cm, immersed in a bath of methylene chloride controlled at 25° C. to remove at least a portion of the diluent with vibration of 100 rpm for 3 minutes, and dried by air flow at room temperature. While holding the size of the membrane substantially constant, the membrane is then heat-set at 125° C. for 10 minutes to produce the final microporous membrane. Selected starting materials, process conditions, and membrane properties are set out in the Table.

The polymers used to produce the membrane, selected process conditions, and selected membrane properties are set out in the Table.

### Examples 2 and 3

Example 1 is repeated except the stretching temperature is 115° C. (Example 2) and 117.5 (Example 3).

### Examples 4-6

Examples 1-3 are repeated, except the diluent is a PAO having a specific gravity (measured at 15.6° C.) of 0.835, a kinematic viscosity (measured at 40° C.) of 66.0 mm²/sec, a viscosity index of 137, and a pour point of −48° C.

### Comparative Examples 1-3

Examples 1-3 are repeated, except the diluent is a liquid paraffin oil (white oil) having a specific gravity (measured at 15.6° C.) of 0.865, a kinematic viscosity (measured at 40° C.) of 56.2 mm²/sec, and a pour point of −12.5° C.

TABLE

| | | Ex. 1 | Ex. 2 | Ex. 3 | Ex. 4 | Ex. 5 | Ex. 6 | C. E. 1 | C. E. 2 | C. E. 3 |
|---|---|---|---|---|---|---|---|---|---|---|
| PE2 | Content (wt. %) | 82.0 | 82.0 | 82.0 | 82.0 | 82.0 | 82.0 | 82.0 | 82.0 | 82.0 |
| PE4 | Content (wt. %) | 18.0 | 18.0 | 18.0 | 18.0 | 18.0 | 18.0 | 18.0 | 18.0 | 18.0 |

| | | | | | | | | | |
|---|---|---|---|---|---|---|---|---|---|
| Processing Condition | | | | | | | | | |
| Polymer content (wt. %) polymer-diluent | 30.0 | 30.0 | 30.0 | 30.0 | 30.0 | 30.0 | 30.0 | 30.0 | 30.0 |
| mixture | | | | | | | | | |
| Extrusion | | | | | | | | | |
| Extrusion Temperature (° C.) | 220 | 220 | 220 | 220 | 220 | 220 | 220 | 220 | 220 |
| Stretching | | | | | | | | | |
| Temperature (° C.) | 112.5 | 115 | 117.5 | 112.5 | 115 | 117.5 | 112.5 | 115 | 117.5 |
| Magnification (MD × TD) | 5 × 5 | 5 × 5 | 5 × 5 | 5 × 5 | 5 × 5 | 5 × 5 | 5 × 5 | 5 × 5 | 5 × 5 |
| Heat Set (° C.) | 125 | 125 | 125 | 125 | 125 | 125 | 125 | 125 | 125 |
| Properties | | | | | | | | | |
| Average Thickness (μm) | 20.2 | 19.5 | 17.0 | 18.6 | 23.0 | 21.6 | 16.2 | 20.9 | 17.2 |
| Porosity (%) | 35.2 | 38.4 | 37.8 | 30.9 | 37.2 | 38.8 | 28.4 | 34.3 | 33.3 |
| Normalized Air Permeability | 32.2 | 21.2 | 20.5 | 48.2 | 27.7 | 25.6 | 50.5 | 30.3 | 33.0 |
| (sec/100 cm³/μm) | | | | | | | | | |
| Normalized Puncture Strength (mN/μm) | 230.3 | 214.6 | 214.1 | 248.9 | 218.5 | 218.5 | 217.1 | 203.8 | 240.1 |
| 105° C. TD Heat Shrinkage (%) | 3.4 | 4.2 | 4.3 | 3.4 | 4.6 | 4.8 | 4.0 | 3.8 | 3.6 |

As shown in the Table, the membranes of Examples 1-6, using the PAO as diluent, have improved porosity and normalized air permeability over the range of stretching temperatures compared to membranes produced using liquid paraffin diluent (Comparative Examples 1-3). Moreover, at lower stretching temperature (e.g., 112.5° C.), the membranes of Examples 1-6 have both improved pin puncture strength and improved TD heat shrinkage over the membranes produced using liquid paraffin (white oil) diluent.

1. A membrane comprising (a) ≧90.0 wt. % polymer (first component) having an Mw≧1.0×10⁵ and (b) ≧0.01 wt. % of an aliphatic paraffin (second component), the aliphatic paraffin having (i) an average carbon number in the range of C₂₀ to C₁₅₀₀ and (ii) ≧1 pendent group having a carbon number ≧C₄ per six backbone carbon atoms, weight percents being based on the weight of the membrane, wherein the membrane is microporous.

2. The membrane of claim 1, wherein the amount of aliphatic paraffin is ≧1.0 wt. % based on the weight of the membrane.

3. The membrane of claim 1, wherein the aliphatic paraffin has ≧2 pendent groups having a carbon number ≧C₄ per six backbone carbon atoms.

4. The membrane of claim 1, wherein the aliphatic paraffin has an Mw≧400.0, an MWD in the range of 1.2 to 3.0, and further comprises 0.0 wt. % to 10.0 wt. % of pendent groups having an average carbon number of C₂ or C₃ based on the weight of the aliphatic hydrocarbon.

5. The membrane of claim 1, wherein (i) the polymer of the first component is polyolefin and (ii) the aliphatic paraffin comprises ≧50.0 wt. % of repeating units derived from α-olefin of at least dimer order, the α-olefin being one or more of 1-octene, 1-nonene, 1-decene, 1-undecene or 1-dodecene.

6. The membrane of claim 5, wherein the polymer of the first component has an MWD≦20.0 and comprises one or more of polyethylene, polypropylene, or polymethylpentene.

7. The membrane of claim 6, wherein the polymer of the first component comprises ≧7.50 wt % polyethylene based on the weight of the polymer of the first component; wherein the membrane comprises ≧0.10 wt. % of the aliphatic hydrocarbon based on the weight of the membrane; and wherein the membrane has a porosity ≧20.0%, a normalized air permeability ≦50.0 second/100 cm³/μm, and a normalized pin puncture strength ≧10×10² mN/μm.

8. The membrane of claim 7, wherein the polyethylene comprises (i) a first polyethylene having an Mw ≦1.0×10⁶, and MWD≦20.0, and a Tm ≧132.0° C. and (ii) a second polyethylene having an Mw≧1.0×10⁶, and MWD≦20.0, and a Tm ≧134.0° C.

9. The membrane of claim 1, wherein the membrane has a thickness ≦25.0 μm, a 105° C. heat shrinkage in at least one direction ≦10.0%, a shutdown temperature ≦140.0° C., and a meltdown temperature ≧145.0° C.; the membrane comprising ≧0.05 wt. % of the aliphatic hydrocarbon and ≦1.0 wt. % of a paraffin containing (i) no pendent groups or (ii) pendent groups having an average carbon number ≦C₃ based on the weight of the membrane.

10. (canceled)

11. A method for producing a microporous membrane, comprising:
Stretching in at least a first direction a sheet comprising ≧5.0 wt. % of a polymer and ≧50.0 wt. % of a diluent, the weight percents being based on the weight of the sheet, wherein the diluent comprises ≧0.01 wt. % based on the weight of the diluent of aliphatic paraffin having (i) an average carbon number in the range of C₂₀ to C₁₅₀₀ and (ii) ≧1 pendent group having a carbon number ≧C₄ per six backbone carbon atoms; and then removing at least a portion of the diluent from the stretched sheet.

12. The method of claim 11, wherein before removing at least a portion of the diluent from the stretched sheet, the sheet comprises 55.0 wt. % to 85.0 wt. % of the aliphatic paraffin and 15.0 wt. % 45.0 wt. % of the polymer, based on the weight of the sheet, and wherein the polymer is one or more of polyethylene, polypropylene, or polymethyl pentene.

13. The method of claim 11, wherein the polymer comprises 45.0 wt. % to 95.0 wt. % of a first polyethylene having an Mw ≦1.0×10⁶, an MWD≦20.0, and a Tm ≧132.0° C. and 5.0 wt. % 40.0 wt. % of a second polyethylene having an Mw≧1.0×10⁶, an MWD≦20.0, and a Tm ≧134.0° C., the weight percents being based on the weight of the polymer of the first component.

14. The method of claim 11, wherein the diluent comprises ≧90.0 wt. % of the aliphatic paraffin, wherein (i) the aliphatic paraffin is a mixture of oligomers of C₈ to C₁₂ linear α-olefins and (ii) the mixture has a kinematic viscosity ≧5.0 mm²/sec at 100° C., a pour point≦−30.0° C., and a flash point≧245° C.

15. The method of claim 14, wherein the mixture has a density ≦0.850, an Mn ≧750.0 a viscosity index ≧125.0, and a kinematic viscosity ≧45.0 mm²/sec at 40° C., and an MWD in the range of from 1.2 to 3.0.

16. The method of claim 11, wherein the sheet is an extrudate, and wherein the stretching is conducted to achieve an area magnification factor ≧5.0 while exposing the extrudate to a temperature in the range of 80.0° C. to 130.0° C.

17. The method of claim 11, further comprising cooling the sheet between the extrusion and the stretching.

18. The method of claim 11, further comprising a second stretching of the sheet, the second stretching being conducted after removing at least a portion of the diluent, wherein the second stretching achieves a magnification factor ≧1.2 in at least one direction.

19. The method of claim 11, wherein the diluent further comprises ≦10.0 wt. % of paraffin containing (i) no pendent groups or (ii) pendent groups having an average carbon number ≦C₃, based on the weight of the diluent.

20. The membrane product of claim 11.

21. A battery comprising an electrolyte, an anode, a cathode, and a separator situated between the anode and the cathode; the separator comprising (a) ≧90.0 wt. % polymer (first component) having an Mw≧1.0×10⁵ and (b) ≧0.01 wt. % aliphatic paraffin (second component), the aliphatic paraffin having (i) an average carbon number in the range of C₂₀ to C₁₅₀₀ and (ii) ≧1 percent group having a carbon number ≧C₄ per six backbone carbon atoms, weight percents being based on the weight of the separator.

22-28. (canceled)
